(19) United States
(12) Patent Application Publication
(10) Pub. No.: US 2025/0030081 A1
(43) Pub. Date: Jan. 23, 2025

(54) BATTERY CELL WITH THERMALLY CONDUCTIVE SIDE WALLS, BATTERY MODULE ASSEMBLY, AND TOOLING ASSEMBLY

(71) Applicant: Wisk Aero LLC, Mountain View, CA (US)

(72) Inventors: Travis Orloff, San Jose, CA (US); Robert Duffy, West Chester, PA (US); Anthony Courville, Mountain View, CA (US)

(73) Assignee: Wisk Aero LLC, Mountain View, CA (US)

(21) Appl. No.: 18/771,148

(22) Filed: Jul. 12, 2024

Related U.S. Application Data
(60) Provisional application No. 63/527,979, filed on Jul. 20, 2023.

(51) Int. Cl. H01M 10/653; H01M 10/04; H01M 10/613; H01M 10/6551; H01M 50/124

(52) U.S. Cl. CPC H01M 10/653; H01M 10/04; H01M 10/613; H01M 10/6551; H01M 50/1245

(57) ABSTRACT

Battery cells with a thermally conductive side wall, methods and tooling for forming the battery cells, and battery modules including the battery cells employ a thermally conductive adhesive to form the thermally conductive side wall. A battery cell includes an energy storing portion, a thermally conductive shell the encloses the energy storing portion, and a thermally conductive adhesive layer. The thermally conductive shell includes a base membrane and a cover membrane. The thermally conductive shell includes a perimeter portion including a perimeter portion of the cover membrane attached to a perimeter portion of the base membrane. A folded portion of the perimeter portion of the thermally conductive shell is bonded to a side surface of the thermally conductive shell via the thermally conductive adhesive to form a thermally conductive side wall of the battery cell.

### CROSS-REFERENCES TO RELATED APPLICATIONS

This application claims benefit under 35 USC § 119(e) to U.S. Provisional Patent Application No. 63/527,979 |filed Jul. 20, 2023, and entitled “BATTERY CELL WITH THERMALLY CONDUCTIVE SIDE WALLS, BATTERY MODULE ASSEMBLY, AND TOOLING ASSEMBLY,” the disclosure of which is incorporated by reference herein in its entirety for all purposes.

### BACKGROUND

Many battery cell modules include multiple battery cells that are connected in series and/or parallel. For battery modules with space and/or weight constraints, it is preferable to tightly pack the battery cells. Battery cells in a battery module, however, may generate a substantial amount of heat that may over-heat the battery module absent sufficient cooling of the battery module.

### BRIEF SUMMARY

The following presents a simplified summary of some embodiments of the invention to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Battery cells with thermally conductive side walls, methods and tooling for forming the battery cells with thermally conductive side walls, and battery modules including the battery cells with thermally conductive side walls are described herein. In many embodiments, each of the battery cells with thermally conductive side walls includes a thermally conductive shell that encloses an energy storing portion of the battery cell. The thermally conductive shell includes a thermally conductive base membrane and a thermally conductive cover membrane that are bonded together along a perimeter edge portion of the thermally conductive shell. In many embodiments, a thermally conductive adhesive is applied to side portions of the perimeter edge portion of the thermally conductive shell and each of the side portions is folded and bonded to a side surface of the thermally conductive shell via the thermally conductive adhesive to form one of the thermally conductive sidewalls. In many embodiments, a battery module includes an array of battery cells with thermally conductive side walls and thermally conductive members that are thermally coupled with the thermally conductive side walls and configured to transfer heat collected from the battery cells via the thermally conductive side walls out of the battery module. Any suitable approach can be used to thermally couple the thermally conductive members with the thermally conductive side walls. For example, in some embodiments, a thermally conductive interface material (e.g., a thermally conductive paste) is disposed between and in contact with the thermally conductive member and the thermally conductive side wall. In many embodiments, a tooling assembly is employed to fold the side wall portions of the perimeter edge portion of the thermally conductive shell following application of the thermally conductive adhesive and restrain the folded side wall portion during curing of the thermally conductive adhesive.

Thus, in one aspect, a battery includes an energy storing portion, a thermally conductive shell, and a first thermally conductive adhesive layer. The thermally conductive shell encloses the energy storing portion. The thermally conductive shell includes a base membrane and a cover membrane. The thermally conductive shell includes a first perimeter portion comprising a first perimeter portion of the cover membrane attached to a first perimeter portion of the base membrane. A folded portion of the first perimeter portion of the thermally conductive shell is bonded to a first side surface of the thermally conductive shell by the first thermally conductive adhesive layer to form a first thermally conductive side wall of the battery cell.

In many embodiments, the thermally conductive shell includes a second perimeter portion that includes a second perimeter portion of the cover membrane attached to a second perimeter portion of the base membrane. The battery cell can include a second thermally conductive adhesive layer via which a folded portion of the second perimeter portion of the thermally conductive shell is bonded to a second side surface of the thermally conductive shell to form a second thermally conductive side wall of the battery cell. In many embodiments, the second thermally conductive side wall is disposed on an opposite side of the battery cell relative to the first thermally conductive side wall. The second thermally conductive side wall can be parallel to the first thermally conductive side wall.

In many embodiments, the first thermally conductive adhesive layer and the second thermally conductive adhesive layer comprise a thermally conductive adhesive. The thermally conductive adhesive can have any suitable configuration. In many embodiments, the thermally conductive adhesive includes a thermally conductive metallic component suspended in an adhesive matrix.

In another aspect, a battery module includes battery cells and a first thermally conductive member. Each of the battery cells includes an energy storing portion, a thermally conductive shell, and a first thermally conductive adhesive layer. The thermally conductive shell encloses the energy storing portion. The thermally conductive shell includes a base membrane and a cover membrane. The thermally conductive shell includes a first perimeter portion comprising a first perimeter portion of the cover membrane attached to a first perimeter portion of the base membrane. A folded portion of the first perimeter portion of the thermally conductive shell is bonded to a first side surface of the thermally conductive shell by the first thermally conductive adhesive layer to form a first thermally conductive side wall of the battery cell. The first thermally conductive member is thermally coupled with the first thermally conductive side wall of each of the battery cells. The first thermally conductive member is configured to transfer heat collected from the battery cells via the first thermally conductive side walls out of the battery module.

The first thermally conductive member can be thermally coupled with the first thermally conductive side wall using any suitable approach. For example, in many embodiments, a thermally conductive paste thermally couples the first thermally conductive member with the first thermally conductive side wall.

The first thermally conductive member can have any suitable configuration for transferring heat out of the battery module. For example, in many embodiment, the first thermally conductive member includes cooling fins.

In many embodiments, the battery module includes a second thermally conductive member. The second thermally conductive member is thermally coupled with second thermally conductive side wall of each of the battery cells. The second thermally conductive member is configured to transfer heat collected from the battery cells via the second thermally conductive side walls out of the battery module.

The first thermally conductive member and the second thermally conductive member can be thermally coupled with the battery cells using any suitable approach. For example, a thermally conductive paste is used to thermally couple the first thermally conductive member with the first thermally conductive side walls and the second thermally conductive member with the second thermally conductive side walls.

The first thermally conductive member and the second thermally conductive member can have any suitable configuration for removing heat from the battery module. For example, in some embodiments, each of the first thermally conductive member and the second thermally conductive member includes cooling fins.

In another aspect, a method of forming a thermally conductive sidewall of a battery is provided. The method includes receiving a battery cell that includes an energy storing portion and a thermally conductive shell that encloses the energy storing portion. The thermally conductive shell includes a base membrane and a cover membrane. The thermally conductive shell includes a first perimeter portion that includes a first perimeter portion of the cover membrane attached to a first perimeter portion of the base membrane. A thermally conductive adhesive is applied to the first perimeter portion of the thermally conductive shell. The first perimeter portion of the thermally conductive shell with the thermally conductive adhesive is folded against a first side wall of the thermally conductive shell. The thermally conductive adhesive is cured to bond the first perimeter portion of the thermally conductive shell to the first side wall of the thermally conductive shell to form the first thermally conductive side wall of the battery cell. The thermally conductive adhesive can include a thermally conductive metallic component suspended in an adhesive matrix.

In many embodiments of the method, the thermally conductive shell includes a second perimeter portion that includes a second perimeter portion of the cover membrane attached to a second perimeter portion of the base membrane. The first perimeter portion and the second perimeter portion are disposed on opposite sides of the battery cell. The thermally conductive adhesive is applied to the second perimeter portion of the thermally conductive shell. The second perimeter portion of the thermally conductive shell with the thermally conductive adhesive is folded against a second side wall of the thermally conductive shell. The thermally conductive adhesive is cured to bond the second perimeter portion of the thermally conductive shell to the second side wall of the thermally conductive shell to form a second thermally conductive side wall of the battery cell.

In many embodiments of the method, the second thermally conductive side wall is disposed on an opposite side of the battery cell relative to the first thermally conductive side wall. The second thermally conductive side wall can be parallel to the first thermally conductive side wall.

In another aspect, a fabrication tool for forming a conductive side wall of a battery cell includes a base member and a second side support assembly. The base member includes a bottom surface, a first side battery cell support surface, and a first side support wall. The second side support assembly includes a second side support base member and a second side support wall member slidably mounted to the second side support base member. The second side support wall member is offset from the first side support wall. The second side support wall member includes a second side battery cell support surface and a second side support wall. The second side support wall member is spring biased away from the second side support base member. The first side battery cell support surface and the second side battery cell support surface are coplanar. The first side support wall and the second side support wall include parallel side wall surfaces configured to retain folded side lengths of perimeter edge portions of a thermally conductive shell of a battery shell into engagement with a respective sidewall of the thermally conductive shell during curing of a conductive adhesive used to bond the folded side lengths of the perimeter edge portion to the respective sidewalls of the thermally conductive shell.

In many embodiments of the fabrication tool, the base member includes a second side recess extending alongside the first side battery cell support surface. A bottom portion of the second side support wall member can be accommodated within the second side recess. The second side recess can be configured to accommodate relative movement between the second side support wall member and the second side support base member.

In many embodiments of the fabrication tool, the second side support base member is detachably mountable to the base member to support the second side support wall member offset from the first side support wall. For example, the second side support base member can include unthreaded fastener holes and the base member can include threaded fastener holes for accommodating threaded fasteners used to secure the second side support base member to the base member.

In many embodiments, the fabrication tool is configured to induce folding of the respective side lengths of a perimeter edge portion of a thermally conductive shell of a battery cell. For example, each of the first side support wall and the second side support wall can include a contoured portion shaped to fold the respective side lengths of a perimeter edge portion of a thermally conductive shell of a battery cell into engagement with a respective sidewall of the thermally conductive shell as the battery cell is advanced into the fabrication tool in contact with the first side battery cell support surface and the second side battery support surface and between the first side support wall and the second side support wall.

For a fuller understanding of the nature and advantages of the present invention, reference should be made to the ensuing detailed description and accompanying drawings.

### BRIEF DESCRIPTION OF THE DRAWINGS

FIG. 1 shows a photograph of a battery cell with thermally conductive side walls, in accordance with embodiments.

FIG. 2 shows a cross-sectional view through the thermally conductive side walls of the battery cell of FIG. 1.

FIG. 3 shows a close-up cross-sectional view through one of the thermally conductive side walls of the battery cell of FIG. 2.

FIG. 4 illustrates internal components of a battery module that includes battery cells with thermally conductive side walls thermally coupled to thermally conductive members configured to transfer heat from the thermally conductive side walls out of the battery module, in accordance with embodiments.

FIG. 5 and FIG. 6 show photographs of a thermally conductive adhesive being applied to side perimeter edge portions of a thermally conductive shell of a battery cell during formation of thermally conductive side walls of the battery cell.

FIG. 7 shows a photograph of the battery cell of FIG. 5 and FIG. 6 with the thermally conductive adhesive applied to the side perimeter edge portions of the thermally conductive shell.

FIG. 8 shows a cross-sectional view through the battery cell with the thermally conductive adhesive applied as illustrated in FIG. 7.

FIG. 9 shows a partially exploded view of a tooling assembly for folding the side perimeter edge portions of the battery cell with the thermally conductive adhesive applied as shown in FIG. 7 and restraining of the battery cell during curing of the thermally conductive adhesive, in accordance with embodiments.

FIG. 10 shows a close-up view illustrating contoured portions of the tooling assembly of FIG. 9 configured to fold the side perimeter edge portions of the battery cell with the thermally conductive adhesive applied as illustrated FIG. 7.

FIG. 11 shows a photograph of the battery cell of FIG. 7 being inserted into the tooling assembly of FIG. 9.

FIG. 12 shows a photograph of the battery cell of FIG. 7 at a greater state of insertion into the tooling assembly of FIG. 9 than for the state of insertion shown in FIG. 11.

FIG. 13 shows a photograph of the battery cell of FIG. 7 fully inserted into the tooling assembly of FIG. 9.

FIG. 14 shows a photograph of removal of excess thermally conductive adhesive from the battery cell of FIG. 7 following insertion into the tooling assembly of FIG. 9.

FIG. 15 shows a photograph of the battery cell of FIG. 7 in the tooling assembly of FIG. 9 during curing of the thermally conductive adhesive.

FIG. 16 shows a photograph of the tooling assembly of FIG. 9 during curing of five instances of the battery cell of FIG. 7.

FIG. 17 is a simplified schematic diagram of a method of forming a thermally conductive side wall of a battery cell, in accordance with embodiments.

### DETAILED DESCRIPTION

In the description herein, various embodiments are described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

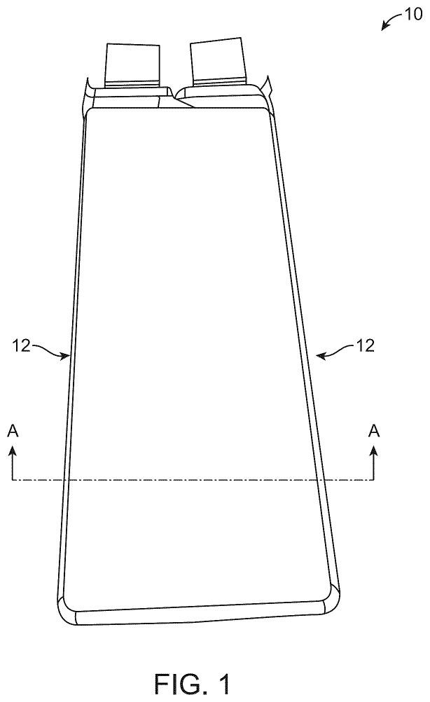

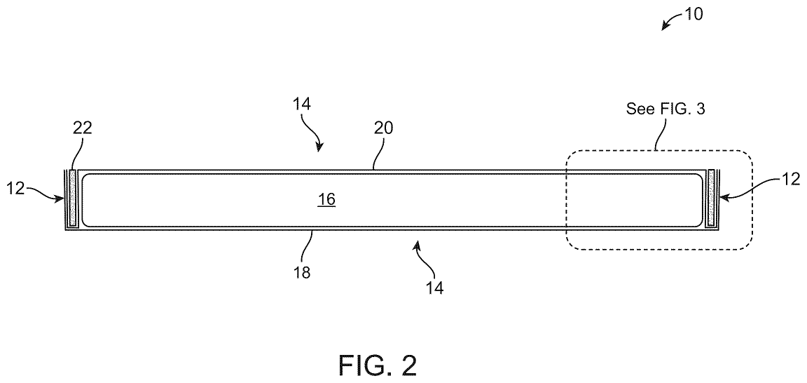

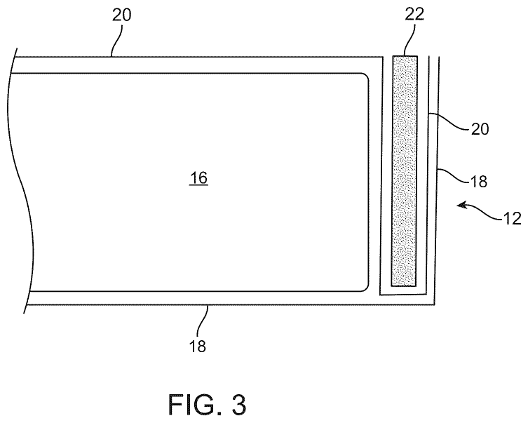

Turning now to the drawing figures in which similar reference numbers refer to similar features in the various drawing figures, FIG. 1 shows a photograph of a battery cell 10 with thermally conductive side walls 12, in accordance with embodiments. FIG. 2 shows a cross-sectional view through the thermally conductive side walls 12 of the battery cell 10. FIG. 3 shows a close-up cross-sectional view through one of the thermally conductive side walls 12. The battery cell 10 includes a thermally conductive shell 14 that encloses an energy storing portion 16 of the battery cell 10. The thermally conductive shell 14 includes a thermally conductive base membrane 18 and a thermally conductive cover membrane 20 that are bonded together along a perimeter edge portion of the thermally conductive shell 14. In many embodiments, a thermally conductive adhesive 22 is applied to side portions of the perimeter edge portion of the thermally conductive shell 14 and each of the side portions is folded and bonded to a side wall of the thermally conductive shell 14 via the thermally conductive adhesive 22 to form one of the thermally conductive sidewalls 12.

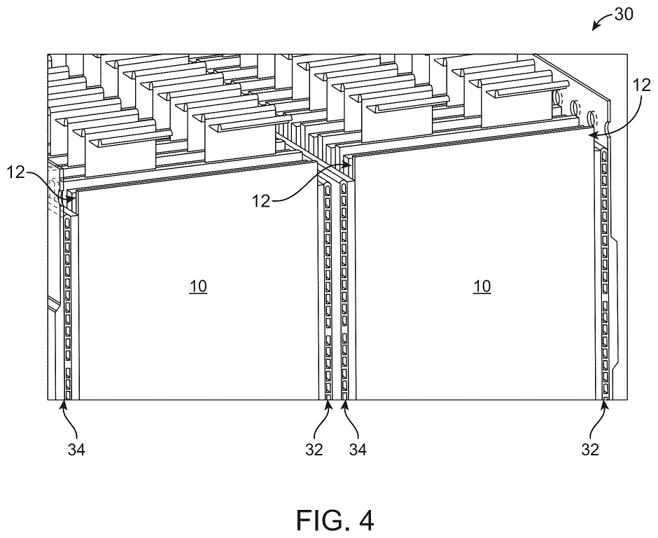

FIG. 4 illustrates internal components of a battery module 30 that includes the battery cells 10, first side thermally conductive members 23, and second side thermally conductive members 34. The thermally conductive side walls 12 are thermally coupled to the first side and second side thermally conductive members 32, 34, which are configured to transfer heat from the thermally conductive side walls 12 out of the battery module 30. As discussed herein, each of the battery cells 10 include a thermally conductive shell 14 that surrounds the energy storage portion 16 of the battery cell 10. Heat from the energy storage portion 16 is transferred to the thermally conductive shell 14. The thermally conductive shell 14 transfers a portion of the heat to the thermally conductive side walls 12. One of the thermally conductive side walls 12 is thermally coupled with the first side thermally conductive member 32. The other thermally conductive side wall 12 is thermally coupled with the second side thermally conductive member 34. To enhance heat transfer, a thermally conductive paste can be disposed between the thermally conductive member 32, 34 and the thermally conductive side wall 12. The first side and second side thermally conductive members 32, 34 can be configured with cooling fins to enhance heat transfer from the thermally conductive member 32, 34 to the surrounding air.

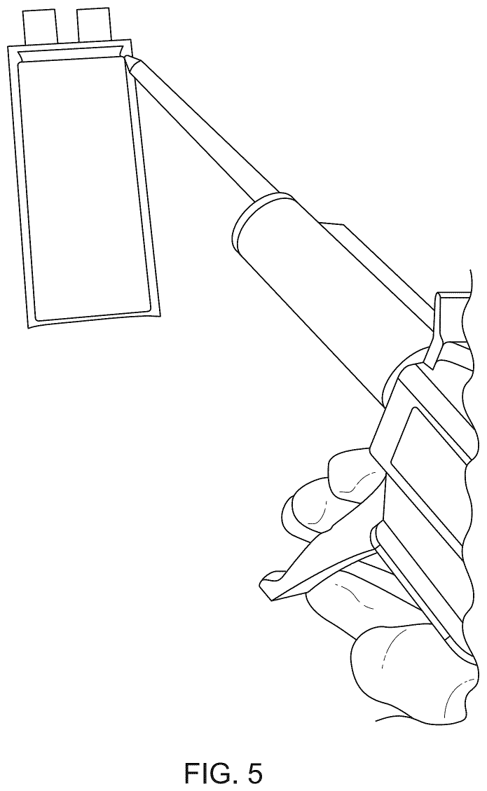

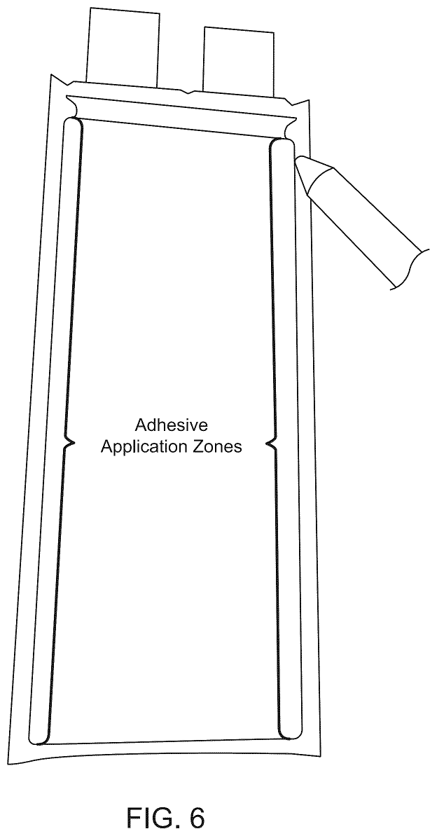

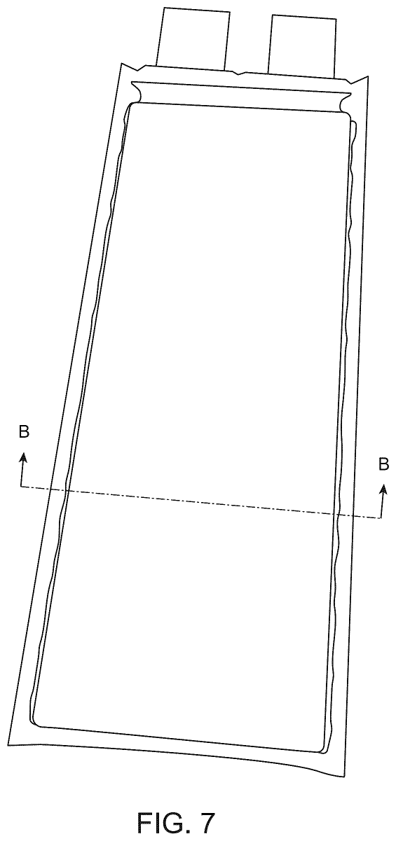

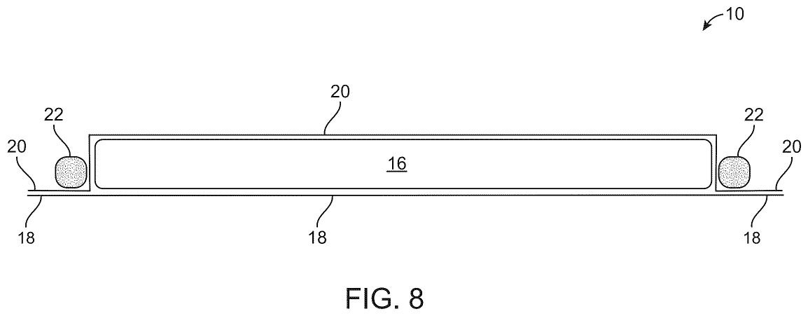

FIG. 5 and FIG. 6 show photographs of the thermally conductive adhesive 22 being applied to side perimeter edge portions of a thermally conductive shell 14 during formation of thermally conductive side walls 12. Any suitable thermally conductive adhesive can be used as the thermally conductive adhesive 22. In some embodiments, the thermally conductive adhesive includes a suitable thermally conductive metallic component suspended in a suitable adhesive matrix. Examples of a suitable thermally conductive adhesive includes CoolTherm® TC-2002 from Parker Hannifin and BT-301-50M from Wakefield Solutions. FIG. 7 shows a photograph of the battery cell of FIG. 5 and FIG. 6 with the thermally conductive adhesive 22 applied to the side perimeter edge portions of the thermally conductive shell 14. FIG. 8 shows a cross-sectional view through the battery cell 10 with the thermally conductive adhesive 22 applied.

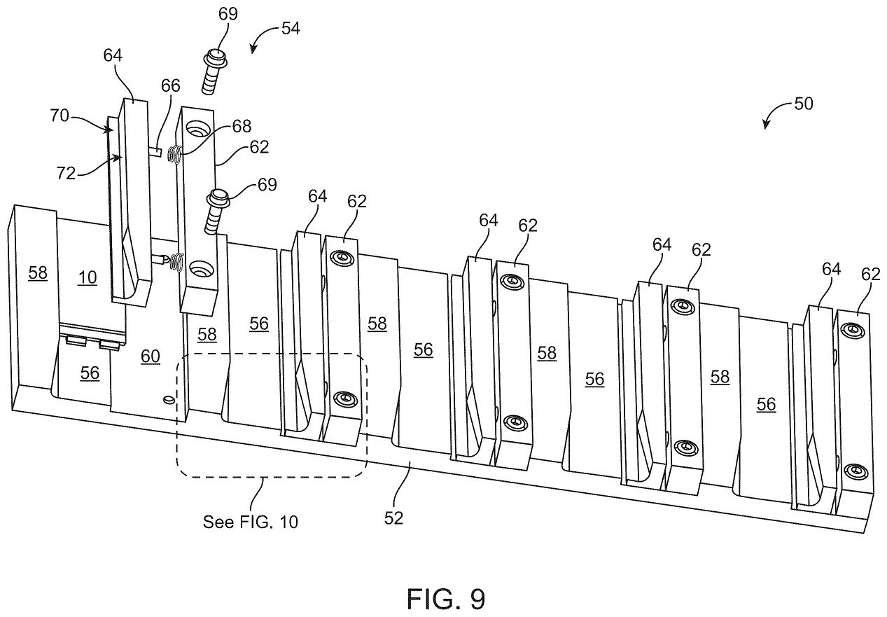

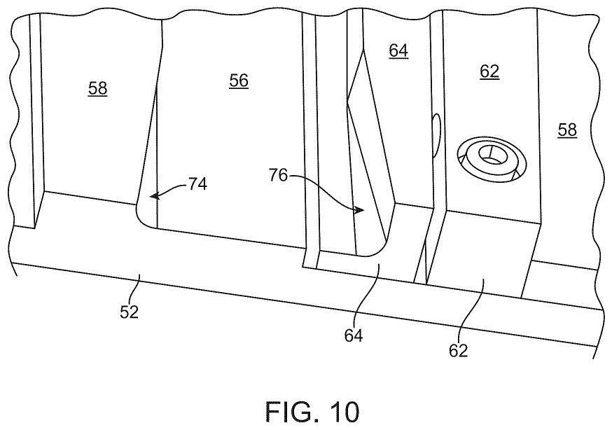

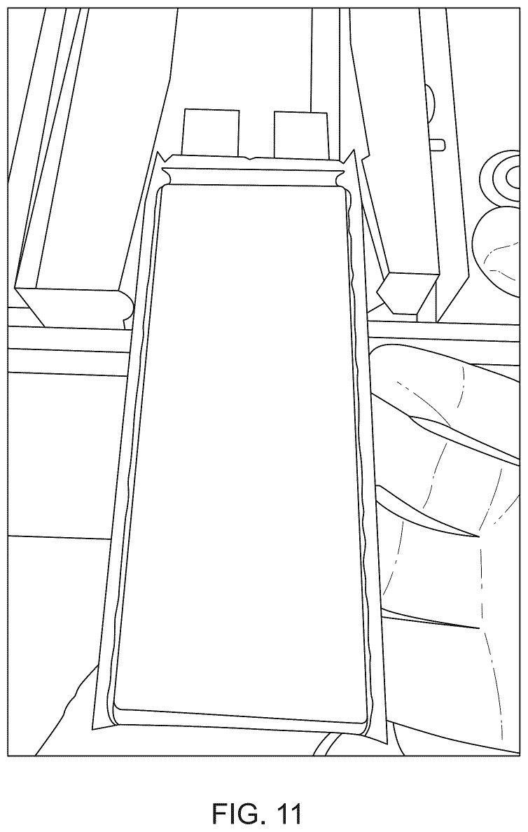

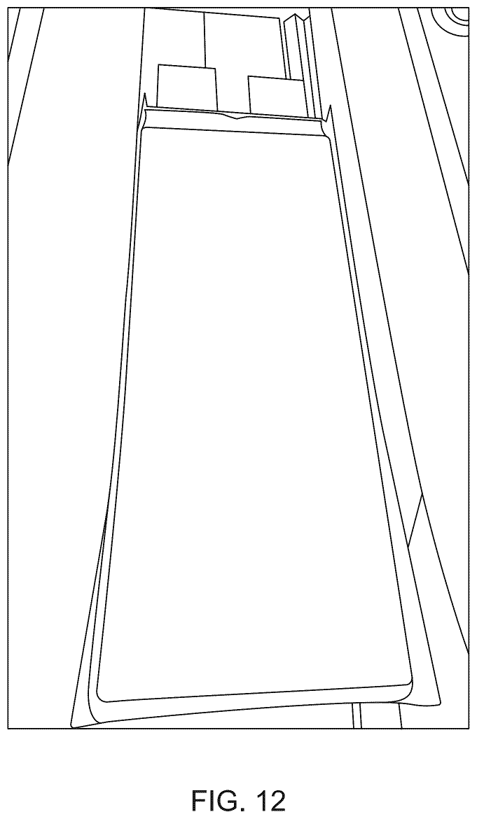

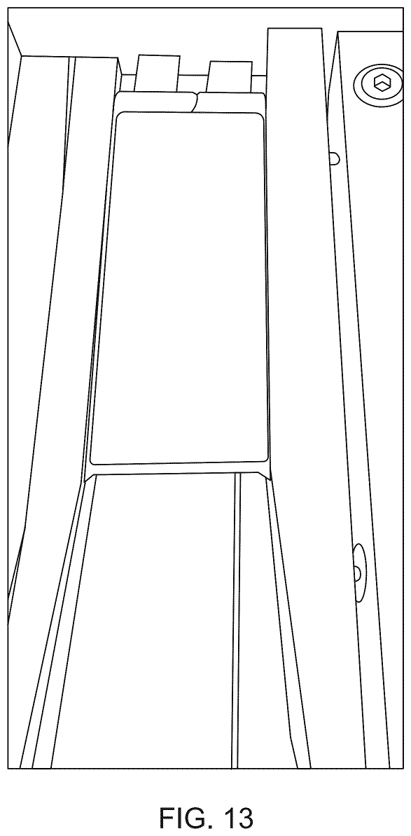

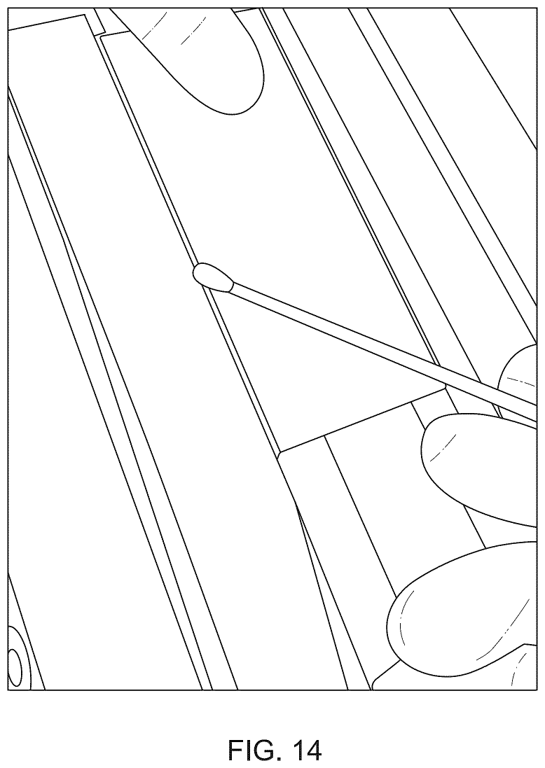

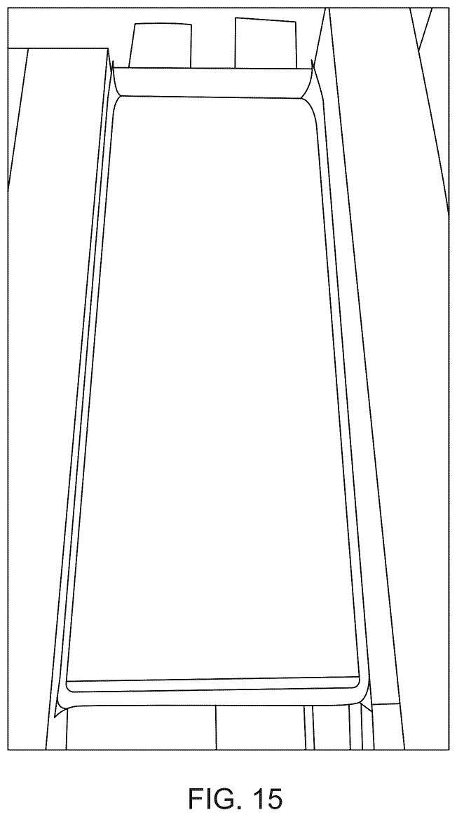

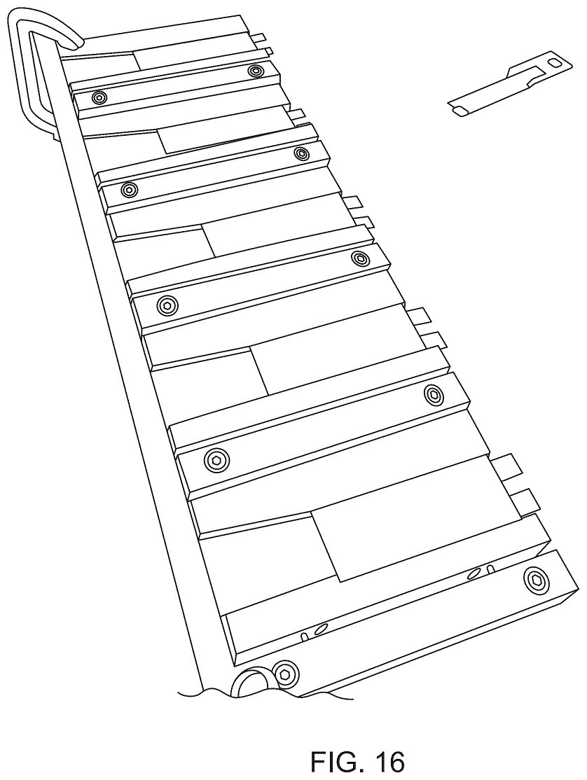

FIG. 9 shows a partially exploded view of a fabrication tool 50 for forming thermal conductive side walls of a battery cell, in accordance with embodiments. The fabrication tool 50 includes a base plate member 52 and second side support wall assemblies 54. The base plate member 52 includes a first side battery cell support surface 56, a first side support wall 58, and a second side recess 60 extending alongside the first side battery cell support surface 56. The second side support wall assembly 54 includes a second side support base member 62 and a second side support wall member 64 slidably mounted to the second side support base member 62 via protruding pins 66 and springs 68. The second side support base member 62 is detachably mountable to the base plate member 52 via bolts 69 to support the second side support wall member 64 offset from the first side support wall 58. The second side support wall member 64 includes a second side battery cell support surface 70 and a second side support wall 72. The second side support wall member 64 is spring biased away from the second side support base member 62 by the springs 68. Bottom portions of the second side support base member 62 and the second side support wall member 64 are accommodated within the second side recess 60. The second side recess 60 is configured to accommodate relative movement between the second side support wall member 64 and the second side support base member 62. The first side battery cell support surface 56 and the second side battery cell support surface 70 are coplanar. The first side support wall 58 and the second side support wall 72 include respective contoured portions 74, 76 shaped to fold respective side lengths of a perimeter edge portion of a thermally conductive shell of a battery cell into engagement with a respective sidewall of the thermally conductive shell as the battery cell is advanced into the fabrication tool 50 in contact with the first side battery cell support surface 56 and the second side battery support surface 70 and between the first side support wall 58 and the second side support wall 72. The first side support wall 58 and the second side support wall 72 include parallel side wall surfaces for retaining the folded side lengths of the perimeter edge portion in a folded configuration during curing of a conductive adhesive used to bond the folded lengths of the perimeter edge portion to the sidewalls of the thermally conductive shell to form the thermally conductive side walls of the battery cell. In the illustrated embodiment, the fabrication tool 50 is configured for processing of five instances of the battery cell 10. FIG. 10 shows a close-up view illustrating the contoured portion 74 of the base plate member 52 and the contoured portion 76 of the second side support wall member 64. The contoured portions 74, 76 are shaped for inducing folding of the side perimeter edge portions of the battery cell 10 during insertion of the battery cell 10 into the tooling assembly 50. The springs 68 push the second side support wall member 64 against one side of the battery cell 10 to maintain a suitable side force against the folded side perimeter edge portions of the battery cell 10 during curing of the thermally conductive adhesive 22. FIG. 11 shows a photograph of the battery cell 10 being inserted into the tooling assembly 50. FIG. 12 shows a photograph of the battery cell 10 at a greater state of insertion into the tooling assembly 10 than for the initial state of insertion shown in FIG. 11. FIG. 13 shows a photograph of the battery cell 10 fully inserted into the tooling assembly 50. FIG. 14 shows a photograph of removal of excess thermally conductive adhesive from the battery cell 10 following insertion into the tooling assembly 50. FIG. 15 shows a photograph of the battery cell 10 in the tooling assembly 50 during curing of the thermally conductive adhesive. FIG. 16 shows a photograph of the tooling assembly 50 during curing of five instances of the battery cell 10.

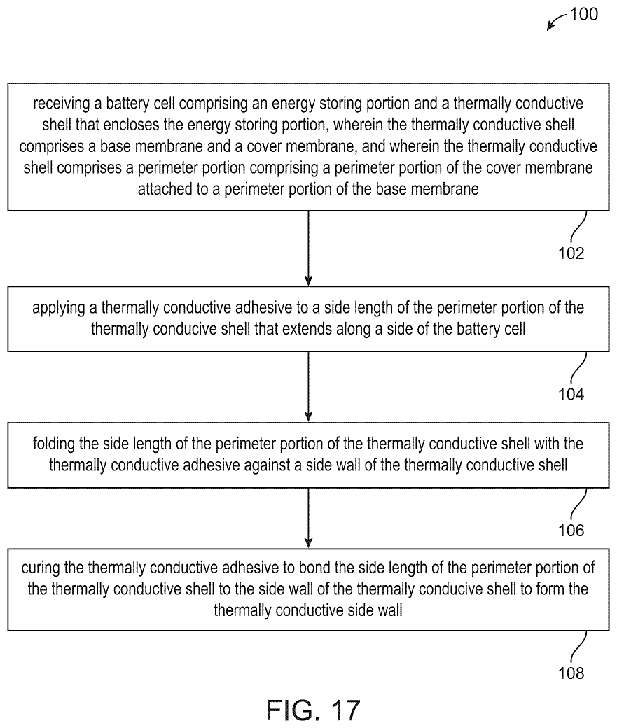

FIG. 17 is a simplified schematic diagram of a method 100 of forming a thermally conductive side wall of a battery cell, in accordance with embodiments. The method 100 can used to form the conductive side walls of any suitable battery cell, such as the battery cell 10. The method 100 can also be practiced using any suitable fabrication tool, such as the fabrication tool 50. The method 100 includes receiving a battery cell comprising an energy storing portion and a thermally conductive shell that encloses the energy storing portion (act 102). The thermally conductive shell includes a base membrane and a cover membrane. The thermally conductive shell includes a perimeter portion including a perimeter portion of the cover membrane attached to a perimeter portion of the base membrane. The method 100 further includes applying a thermally conductive adhesive to a side length of the perimeter portion of the thermally conducive shell that extends along a side of the battery cell (act 104), folding the side length of the perimeter portion of the thermally conductive shell with the thermally conductive adhesive against a side wall of the thermally conductive shell (act 106), and curing the thermally conductive adhesive to bond the side length of the perimeter portion of the thermally conductive shell to the side wall of the thermally conducive shell to form the thermally conductive side wall (act 108).

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i. e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e. g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A battery cell comprising:
an energy storing portion;
a thermally conductive shell that encloses the energy storing portion, wherein the thermally conductive shell comprises a base membrane and a cover membrane, and wherein the thermally conductive shell comprises a first perimeter portion comprising a first perimeter portion of the cover membrane attached to a first perimeter portion of the base membrane; and
a first thermally conductive adhesive layer via which a folded portion of the first perimeter portion of the thermally conductive shell is bonded to a first side surface of the thermally conductive shell to form a first thermally conductive side wall of the battery cell.

2. The battery cell of claim 1, wherein the thermally conductive shell comprises a second perimeter portion comprising a second perimeter portion of the cover membrane attached to a second perimeter portion of the base membrane, and further comprising a second thermally conductive adhesive layer via which a folded portion of the second perimeter portion of the thermally conductive shell is bonded to a second side surface of the thermally conductive shell to form a second thermally conductive side wall of the battery cell.

3. The battery cell of claim 2, wherein the second thermally conductive side wall is disposed on an opposite side of the battery cell relative to the first thermally conductive side wall.

4. The battery cell of claim 3, wherein second thermally conductive side wall is parallel to the first thermally conductive side wall.

5. The battery cell of claim 2, wherein each of the first thermally conductive adhesive layer and the second thermally conductive adhesive layer comprises a thermally conductive adhesive that comprises a thermally conductive metallic component suspended in an adhesive matrix.

6. A battery module comprising:
battery cells, wherein each of the battery cells is in accordance with the battery cell of claim 1; and
a first thermally conductive member thermally coupled with the first thermally conductive side wall of each of the battery cells, wherein the first thermally conductive member is configured to transfer heat collected from the battery cells via the first thermally conductive side wall out of the battery module.

7. A battery module of claim 6, wherein a thermally conductive paste thermally couples the first thermally conductive member with the first thermally conductive side wall.

8. A battery module of claim 6, wherein the first thermally conductive member comprises cooling fins.

9. A battery module comprising:
battery cells, wherein each of the battery cells is in accordance with the battery cell of claim 2;
a first thermally conductive member thermally coupled with the first thermally conductive side wall of each of the battery cells, wherein the first thermally conductive member is configured to transfer heat collected from the battery cells via the first thermally conductive side wall out of the battery module; and
a second thermally conductive member thermally coupled with the second thermally conductive side wall of each of the battery cells, wherein the second thermally conductive member is configured to transfer heat collected from the battery cells via the second thermally conductive side wall out of the battery module.

10. A battery module of claim 9, wherein a thermally conductive paste thermally couples:
the first thermally conductive member with the first thermally conductive side walls; and
the second thermally conductive member with the second thermally conductive side walls.

11. A battery module of claim 9, wherein each of the first thermally conductive member and the second thermally conductive member comprises cooling fins.

12. A method comprising:
receiving a battery cell comprising an energy storing portion and a thermally conductive shell that encloses the energy storing portion, wherein the thermally conductive shell comprises a base membrane and a cover membrane, and wherein the thermally conductive shell comprises a first perimeter portion comprising a first perimeter portion of the cover membrane attached to a first perimeter portion of the base membrane;
applying a thermally conductive adhesive to the first perimeter portion of the thermally conductive shell;
folding the first perimeter portion of the thermally conductive shell with the thermally conductive adhesive against a first side wall of the thermally conductive shell; and
curing the thermally conductive adhesive to bond the first perimeter portion of the thermally conductive shell to the first side wall of the thermally conductive shell to form a first thermally conductive side wall of the battery cell.

13. The method of claim 12, wherein the thermally conductive shell comprises a second perimeter portion comprising a second perimeter portion of the cover membrane attached to a second perimeter portion of the base membrane, wherein the first perimeter portion and the second perimeter portion are disposed on opposite sides of the battery cell, and wherein the method further comprises:
applying the thermally conductive adhesive to the second perimeter portion of the thermally conductive shell;
folding the second perimeter portion of the thermally conductive shell with the thermally conductive adhesive against a second side wall of the thermally conductive shell; and
curing the thermally conductive adhesive to bond the second perimeter portion of the thermally conductive shell to the second side wall of the thermally conductive shell to form a second thermally conductive side wall of the battery cell.

14. The method of claim 13, wherein the second thermally conductive side wall is disposed on an opposite side of the battery cell relative to the first thermally conductive side wall.

15. The method of claim 14, wherein the second thermally conductive side wall is parallel to the first thermally conductive side wall.

16. The method of claim 12, wherein the thermally conductive adhesive comprises a thermally conductive metallic component suspended in an adhesive matrix.

17. A fabrication tool comprising:
a base member comprising a bottom surface, a first side battery cell support surface, and a first side support wall; and
a second side support assembly comprising a second side support base member and a second side support wall member slidably mounted to the second side support base member,
wherein:
the second side support wall member is offset from the first side support wall,
the second side support wall member comprises a second side battery cell support surface and a second side support wall,
the second side support wall member is spring biased away from the second side support base member,
the first side battery cell support surface and the second side battery cell support surface are coplanar, and
the first side support wall and the second side support wall comprise parallel side wall surfaces configured to retain folded side lengths of perimeter edge portions of a thermally conductive shell of a battery shell into engagement with a respective sidewall of the thermally conductive shell during curing of a conductive adhesive used to bond the folded side lengths of the perimeter edge portion to the respective sidewalls of the thermally conductive shell.

18. The fabrication tool of claim 17, wherein:
the base member comprises a second side recess extending alongside the first side battery cell support surface;
a bottom portion of the second side support wall member is accommodated within the second side recess; and
the second side recess is configured to accommodate relative movement between the second side support wall member and the second side support base member.

19. The fabrication tool of claim 18, wherein the second side support base member is detachably mountable to the base member to support the second side support wall member offset from the first side support wall.

20. The fabrication tool of claim 19, wherein each of the first side support wall and the second side support wall comprises a contoured portion shaped to fold the respective side lengths of a perimeter edge portion of a thermally conductive shell of a battery cell into engagement with a respective sidewall of the thermally conductive shell as the battery cell is advanced into the fabrication tool in contact with the first side battery cell support surface and the second side battery support surface and between the first side support wall and the second side support wall.
